(19) United States
(12) Patent Application Publication
(10) Pub. No.: US 2011/0151251 A1
(43) Pub. Date: Jun. 23, 2011

(54) ADHESIVE COMPOSITION FOR PLASTICIZER-FREE, SELF-ADHESIVE REMOVABLE LABELS

(75) Inventors: Karl-Heinz Schumacher, Neustadt (DE); Carmen-Elena Cimpeanu, Ludwigshafen (DE)

(73) Assignee: BASF SE, Ludwigshafen (DE)

(21) Appl. No.: 13/060,283

(22) PCT Filed: Sep. 1, 2009
(86) PCT No.: PCT/EP09/61233

§ 371 Date: Feb. 23, 2011

(30) Foreign Application Priority Data
Sep. 12, 2008 (EP) 08164274.6

(51) Int. Cl. B32B 7/12; C09J 133/08; B32B 37/12

(52) U.S. Cl. 428/355 AC; 526/318.44; 526/318.4; 524/522; 156/332

(57) ABSTRACT

A description is given of an adhesive composition which comprises a polymer preferably in the form of an emulsion polymer in dispersion in water. The emulsion polymer has a glass transition temperature of less than −61° C. and is preparable by emulsion polymerization at temperatures less than 80° C. from 80-95% by weight of 2-ethylhexyl acrylate and 5-20% by weight of further, ethylenically unsaturated, free-radically copolymerizable monomers, of which 0.2% to 2% by weight, based on the total amount of monomers, are acid-containing comonomers. The adhesive composition can be used in particular as a pressure-sensitive adhesive for producing plasticizer-free, self-adhesive, redetachable paper labels.

The invention relates to adhesive compositions which comprise a polymer, preferably in dispersion in water, with a low glass transition temperature, said polymer being preparable at comparatively low polymerization temperatures from 2-ethylhexyl acrylate and from further, ethylenically unsaturated, free-radically copolymerizable monomers, of which some are acid-containing comonomers. The invention also relates to labels coated with the adhesive composition and to processes for producing plasticizer-free, self-adhesive, redetachable paper labels.

Redetachable labels are used for the temporary labeling of articles, the intention being that the labels after use should be redetached from the labeled surface with as far as possible no residue. One example are paper labels which are typically adhered to the back of books, comprise information concerning the producer, retailer or price, and can be removed by the ultimate purchaser of the book. Nowadays, for redetachable paper labels, as well as solventborne adhesives and hot melts, aqueous adhesives as well are being used that comprise plasticizer. The purpose of the plasticizer is to ensure sufficiently low adhesion values and ready redetachability of the labels. A disadvantage of these plasticizers is that they can migrate from the adhesive through the label paper to its surface. This migration to the surface is also referred to as “strikethrough behavior”. A poor strikethrough behavior, i.e. the migration of a considerable amount of plasticizer or of other low molecular mass constituents of the adhesive composition from the adhesive-coated reverse of the label through the label to the label surface, can lead to problems when the label surfaces are printed. In that case the label surface can no longer be flawlessly printed. Strikethrough behavior may also occur, as a result of the mode of preparation, in pressure-sensitive adhesive dispersions based on adhesive polymers comprising low molecular mass oligomeric compounds. Furthermore, plasticizer in the adhesive can lead to the rapid fading of colors which have been produced in thermal papers by exposure to heat. Reducing the amount employed, or abandoning plasticizer, in conventional aqueous labeling adhesives entails poor detachability, and so there is a risk that, when the label is detached, residues of adhesive or residues of label will remain on the labeled article, particularly since, in the course of the aging of the bond, the adhesion values frequently rise.

EP 1036802 A1 describes a process for preparing an aqueous polymer dispersion for redetachable films of pressure-sensitive adhesive. The selection of monomers and of the amount of comonomers is such that the resulting polymers have a glass transition temperature of −60° C. to 0° C. For use as pressure-sensitive adhesives, the polymer dispersions may be modified with additives including plasticizers.

The problem, therefore, was to provide an adhesive composition, based preferably on water as the carrier material, for plasticizer-free, redetachable, self-adhesive paper labels that have good strikethrough behavior, have sufficiently low adhesion values that rise only a little, or not at all, in the course of aging of the bond, and, therefore, have good redetachability.

The invention provides an adhesive composition comprising at least one polymer preparable by polymerizing
(i) 80-95% by weight, based on the total amount of monomers, of 2-ethylhexyl acrylate,
(ii) 5-20% by weight, based on the total amount of monomers, of further ethylenically unsaturated, free-radically copolymerizable monomers different from (i), of which 0.2% to 2% by weight, based on the total amount of monomers, are comonomers comprising acid groups, more particularly comonomers containing carboxylic acid,
   the polymer having a glass transition temperature of less than −61° C. and the polymerization being carried out at temperatures less than 80° C.

The invention provides more particularly an aqueous pressure-sensitive adhesive composition comprising at least one emulsion polymer, in dispersion in water, preparable by emulsion polymerization of
(i) 80-95% by weight, based on the total amount of monomers, of 2-ethylhexyl acrylate,
(ii) 5-20% by weight, based on the total amount of monomers, of further ethylenically unsaturated, free-radically copolymerizable monomers, of which 0.2% to 2% by weight, based on the total amount of monomers, are comonomers containing carboxylic acid,
   the emulsion polymer having a glass transition temperature of less than −61° C. and the emulsion polymerization being carried out at temperatures less than 80° C.

The invention also provides a label which is self-adhesive and redetachable and has been coated at least partly with a pressure-sensitive adhesive of the invention.

The invention also provides a process for producing substantially plasticizer-free, self-adhesive, redetachable paper labels, which involves providing a substantially plasticizer-free, pressure-sensitive adhesive of the invention and coating a paper label at least partly with the pressure-sensitive adhesive.

The designation (meth)acrylate and similar designations are occasionally used below as an abbreviated notation for “acrylate or methacrylate”.

The composition comprises at least one organic polymer. This polymer is adhesive, i.e., is capable of connecting substrates without the substrates themselves being notably altered, the holding-together of the connected substrates being determined by forces of adhesion (forces of attraction between adhesive and substrate) and cohesion (internal holding-together of the adhesive). The polymers are obtainable by free-radical polymerization of free-radically polymerizable, ethylenically unsaturated compounds (monomers). Particular preference is given to emulsion polymers, i.e., the reaction products of the polymerization of the monomers in aqueous dispersion.

The polymer is formed from 80% to 95% by weight, preferably 82% to 93% by weight, based on the total amount of monomers, of 2-ethylhexyl acrylate. The polymer is additionally formed from 5-20% by weight, preferably 7% to 18% by weight, based on the total amount, of further ethylenically unsaturated, free-radically copolymerizable monomers other than 2-ethylhexyl acrylate. Of the further monomers, 0.2% to 2% by weight, preferably 0.4% to 1.8% by weight, based on the total amount of monomers, are acid-containing comonomers, more particularly comonomers containing carboxylic acid. The monomers of the further monomers that do not comprise acid groups are preferably selected from C1-C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Examples of suitable further monomers are (meth)acrylic acid alkyl esters having a C1-C10 alkyl radical, such as methyl methacrylate, methyl acrylate, n-butyl acrylate, and ethyl acrylate. Also suitable in particular are mixtures of the (meth)acrylic acid alkyl esters. Vinyl esters of carboxylic acids having 1 to 20 C atoms are, for example, vinyl laurate, vinyl stearate, vinyl propionate, Versatic acid vinyl esters, and vinyl acetate. Suitable vinylaromatic compounds include vinyltoluene, a- and p-methylstyrene, a-butylstyrene, 4-n-butylstyrene, 4-n-decylstyrene, and, preferably, styrene. Examples of nitriles are acrylonitrile and methacrylonitrile. The vinyl halides are ethylenically unsaturated compounds substituted by chloro, fluoro or bromo, preferably vinyl chloride and vinylidene chloride. Examples of vinyl ethers include vinyl methyl ether or vinyl isobutyl ether. Preferred vinyl ethers are those of alcohols comprising 1 to 4 C atoms. Suitable hydrocarbons having 4 to 8 C atoms and two olefinic double bonds are, for example, butadiene, isoprene, and chloroprene. Further monomers are, for example, also monomers comprising hydroxyl groups, especially C1-C10 hydroxyalkyl (meth)acrylates or (meth)acrylamide. Further monomers include, moreover, phenyloxy-ethylglycol mono(meth)acrylate, glycidyl (meth)acrylate, aminoalkyl (meth)acrylates such as 2-aminoethyl (meth)acrylate, for example. Alkyl groups preferably have from 1 to 20 C atoms. Further monomers that may be mentioned also include crosslinking monomers.

Preferred further monomers are C1 to C10 alkyl acrylates and C1 to C10 alkyl methacrylates, especially C1 to C8 alkyl acrylates and methacrylates, vinylaromatics, especially styrene, and hydrocarbons having 4 to 8 C atoms and two olefinic double bonds, more particularly butadiene, and mixtures of these monomers. Very particular preference is given to methyl acrylate, methyl methacrylate, ethyl acrylate, n-butyl acrylate, n-hexyl acrylate, octyl acrylate, styrene, butadiene, and mixtures of these monomers.

Besides the further monomers containing no acid groups, the polymer comprises further monomers comprising acid groups, examples being monomers having carboxylic, sulfonic or phosphonic acid groups. Carboxylic acid groups are preferred. Examples that may be mentioned include acrylic acid, methacrylic acid, itaconic acid, maleic acid or fumaric acid. The acid groups may be present in protonated form or in the form of their salts.

More particularly the polymer is composed of at least 5%, more preferably at least 7%, by weight of C1 to C20 alkyl (meth)acrylates other than 2-ethylhexyl acrylate, and of at least 0.5% by weight of acrylic acid.

The nature and amount of the monomers and the proportions of different comonomers relative to one another are such that the glass transition temperature is less than −61° C., such as from −80 to −62° C., for example. The glass transition temperature can be determined by customary methods such as differential scanning calorimetry (see, for example, ASTM 3418/82, midpoint temperature).

The polymers are prepared preferably as an emulsion polymer by emulsion polymerization. The emulsion polymerization takes place using emulsifiers and/or protective colloids and/or stabilizers as surface-active substances. As surface-active substances it is preferred to use exclusively emulsifiers, whose molecular weights, in contradistinction to those of the protective colloids, are typically below 2000 g/mol. It is preferred to use anionic and nonionic emulsifiers as surface-active substances. Customary emulsifiers are, for example, ethoxylated fatty alcohols (EO degree: 3 to 50, alkyl radical: C8 to C36), ethoxylated mono-, di- and tri-alkylphenols (EO degree: 3 to 50, alkyl radical: C4 to C9), and alkali metal salts and ammonium salts of alkyl sulfates (alkyl radical: C8 to C12), of ethoxylated alkanols (EC degree: 4 to 30, alkyl radical: C12 to C18), of ethoxylated alkyl phenols (EO degree: 3 to 50, alkyl radical: C4 to C9), of alkylsulfonic acids (alkyl radical: C12 to C18), and of alkylarylsulfonic acids (alkyl radical: C9 to C18). Commercial products of suitable emulsifiers are, for example, Dowfax® 2 A1, Emulan® NP 50, Dextrol® OC 50, Emulgator 825, Emulgator 825 S, Emulan® OG, Texapon® NSO, Nekanil® 904 S, Disponil® FES 77, Lutensol® AT 18, Steinapol VSL, Emulphor NPS 25.

In one preferred embodiment of the invention the emulsion polymer is prepared in the presence of a mixture of at least one first anionic emulsifier and at least one second anionic emulsifier, the first emulsifier being an alkylarylsulfonate and the second emulsifier being an ethoxylated fatty alcohol sulfate. Alkylarylsulfonates are compounds which contain at least one alkyl group (preferably one), at least one aryl group (preferably one or two) and at least one sulfonic acid group or sulfonate group (preferably one or two). The alkyl group preferably has 8 to 20 C atoms. Aryl is preferably phenyl. The weight ratio of first to second anionic emulsifier may be, for example, from 1:5 to 5:1. Examples of suitable alkylarylsulfonates are alkylbenzenesulfonates, where the alkyl group may contain 8 to 20 C atoms, an example being sodium n-alkyl (C10-C13)-benzene sulfonate. Further suitable alkylarylsulfonates are alkyldiphenyl oxide disulfonates, where the alkyl group may contain 8 to 20 C atoms, an example being disodium dodecyldiphenyl ether disulfonate. The ethoxylated fatty alcohol sulfates may contain, for example, 8 to 20 C atoms in the fatty alkyl chain, examples being sodium lauryl ether sulfate or sodium C12/14-alkyl polyglycol ether sulfate.

The emulsion polymerization may be initiated using water-soluble initiators. Water-soluble initiators are, for example, ammonium salts and alkali metal salts of peroxo-disulfuric acid, e.g. sodium peroxodisulfate, hydrogen peroxide or organic peroxides, e.g., tert-butyl hydroperoxide. Also suitable as initiator are what are called reduction-oxidation (redox) initiator systems. The redox initiator systems are composed of at least one, usually inorganic, reducing agent and an organic or inorganic oxidizing agent. The oxidizing component comprises, for example, the emulsion polymerization initiators already mentioned above. The reducing component comprises, for example, alkali metal salts or sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator systems can be used in conjunction with soluble metal compounds whose metallic component is able to occur in a plurality of valence states. Examples of customary redox initiator systems include ascorbic acid/iron(II) sulfate/sodium peroxodisulfate, tert-butyl hydroperoxide/sodium disulfite, tert-butyl hydroperoxide/Na hydroxymethane-sulfinate. The individual components, the reducing component for example, may also be mixtures, such as a mixture of the sodium salt of hydroxymethanesulfinic acid with sodium disulfite, for example. It is also possible for two or more different initiators to be used for the emulsion polymerization.

One preferred embodiment of the invention uses one or more initiators, the total amount of initiator being less than 0.4 pphm (parts per hundred monomer; parts by weight per hundred parts by weight of monomer), in particular not more than 0.3 pphm, e.g., from 0.1 or from 0.2 to 0.3 pphm.

In the polymerization it is possible to use molecular weight regulators, in amounts, for example, of 0.1 to 0.8 part by weight, per 100 parts by weight of the monomers to be polymerized. By this means it is possible to reduce the molar mass of the emulsion polymer. Suitable compounds are, for example, those having a thiol group, such as tert-butyl mercaptan, thioglycolic acid ethylacrylic esters, mercaptoethanol, mercapto-propyltrimethoxysilane or tert-dodecyl mercaptan. One preferred embodiment uses no molecular weight regulators.

The polymerization medium may be composed either of water alone or of mixtures of water and water-miscible liquids such as methanol. It is preferred to use water alone. The emulsion polymerization may be carried out either as a batch operation or in the form of a feed process, including staged or gradient procedures. Preference is given to the feed process, where a portion of the polymerization batch is introduced as an initial charge and heated to the polymerization temperature, polymerization is commenced, and then the remainder of the polymerization batch is supplied to the polymerization zone continuously, in stages or under a concentration gradient, while the polymerization is maintained. In the polymerization it is also possible to include a polymer seed in the initial charge, for the purpose, for example, of improved regulation of the particle size.

The emulsion polymerization produces aqueous dispersions of the polymer which have solids contents in general of 15% to 75%, preferably of 20% to 70% or of 40% to 70% by weight. In one embodiment the dispersion, or the pressure-sensitive adhesive, comprises at least 60% by weight of dispersed polymer. In order to be able to achieve solids contents>60% by weight, a bimodal or polymodal particle size ought to be set, since otherwise the viscosity becomes too high and the dispersion can no longer be managed. Producing a new generation of particles can be accomplished, for example, by adding seed before or during the emulsion polymerization, by adding excess quantities of emulsifier, or by adding miniemulsions. A further advantage associated with the combination of low viscosity and high solids content is the improved coating behavior at high solids contents. Producing one or more new generations of particles can be done at any desired point in time. It is guided by the target particle size distribution for a low viscosity.

The polymers for use in accordance with the invention are employed preferably in the form of an aqueous dispersion. The average particle size of the polymer particles that are dispersed in the aqueous dispersion is preferably from 100 to 500 nm. The size distribution of the dispersion particles may be monomodal, bimodal or multimodal. In the case of monomodal particle size distribution, the average particle size of the polymer particles dispersed in the aqueous dispersion is preferably less than 500 nm. In the case of bimodal or multimodal particle size distribution, the particle size may also be up to 1000 nm. By average particle size here is meant the d50 value of the particle size distribution, i.e., 50% by weight of the total mass of all the particles have a particle diameter smaller than the d50 value. The particle size distribution can be determined in a known way using the analytical ultracentrifuge (W. Mächtle, Makromolekulare Chemie 185 (1984), pages 1025-1039).

The solution medium or dispersion medium of the adhesive composition may be composed either of water or of mixtures of water and water-miscible liquids such as methanol or ethanol. It is preferred to use just water. The pH of the polymer dispersion or of the adhesive composition is set preferably to greater than 4.5, more particularly to a pH value between 5 and 9.5.

The adhesive compositions may be composed solely of the solvent and the polymer. Alternatively the adhesive composition may also comprise further additives, examples being fillers, dyes, flow control agents, thickeners (preferably associative thickeners), defoamers, pigments, wetting agents or tackifiers (tackifying resins). For improved surface wetting, the adhesives may comprise wetting assistants, examples being fatty alcohol ethoxylates, alkylphenol ethoxylates, nonylphenol ethoxylates, polyoxy-ethylenes, polyoxypropylenes or sodium dodecylsulfonates. The amount of additives is generally 0.05 to 5 parts by weight, more particularly 0.1 to 3 parts by weight, per 100 parts by weight of polymer (solids).

In one embodiment the adhesive composition is substantially free from plasticizers. Plasticizers are adjuvants which lower the bond strength. Substantially free of plasticizers means that the compositions comprise less than 1% by weight, preferably less than 0.5% by weight, based on the overall composition of plasticizers, and with particular preference comprise no plasticizer.

In one embodiment the adhesive composition of the invention is an aqueous dispersion of a polymer which is formed from
(i) 80-95% by weight, based on the total amount of monomers, of 2-ethylhexyl acrylate,
(ii) 3-18% by weight, based on the total amount of monomers, of C1 to C10 alkyl (meth)acrylate, and
(iii) 0.2 to 2% by weight, based on the total amount of monomers, of monomers selected from acrylic acid and methacrylic acid,
   the polymer having a glass transition temperature of less than −61° C., and the polymerization being carried out as an emulsion polymerization at temperatures less than 80° C.

The adhesive composition of the invention is preferably a pressure-sensitive adhesive (PSA). A PSA is a viscoelastic adhesive whose set film at room temperature (20° C.) in the dry state remains permanently tacky and adhesive. The bonding to substrates takes place immediately, upon gentle applied pressure.

The adhesive composition of the invention can be used for producing self-adhesive articles. The articles are at least partly coated with the PSA. The self-adhesive articles can preferably be removed again after bonding. The self-adhesive articles may be, for example, sheets, tapes or labels. Examples of suitable backing materials include paper, polymeric films, and metal foils. In the case of self-adhesive tapes of the invention, the tapes may be single-sidedly or double-sidedly coated tapes comprising the substances above. In the case of self-adhesive labels of the invention, the labels may, be of paper or of a thermoplastic film. Suitable thermoplastic films include, for example, films of polyolefins (e.g., polyethylene, polypropylene), polyolefincopolymers, films of polyesters (e.g., polyethylene terephthalate) or polyacetate. The surfaces of the thermoplastic polymer films are preferably corona-treated. The labels are coated with adhesive on one side. Preferred substrates for the self-adhesive articles are paper and polymer films. Preferred self-adhesive articles are paper labels.

The articles are coated on at least one surface at least partly with an adhesive composition of the invention. The adhesive may be applied to the articles by typical methods such as knife coating or spreading. The amount applied is preferably 0.1 to 20 g, more preferably 2 to 15 g, of solid per m². Application is generally followed by a drying step for removing the water and/or the solvents.

The substrates to which the self-adhesive articles can advantageously be applied may be, for example, metal, wood, glass, paper or plastic. The self-adhesive articles are suitable more particularly for bonding to packaging surfaces, cartons, plastic packaging, books, windows, motor vehicle bodies or bodywork parts. The self-adhesive articles of preferred embodiments can be removed from the articles again by hand, without residue of adhesive on the article. Adhesion to the articles is good, and yet the sheets, tapes, and labels are readily removable. This good removability is retained even after a relatively long time. Paper labels exhibit good strikethrough behavior and good printability.

One embodiment of the invention is a paper label which has a first surface and a second surface, the first surface being self-adhesive and being coated at least partly with a pressure-sensitive adhesive composition of the invention, and the second surface being printed, or the second surface or the label being at least partly colored. This coloration may have been produced, for example, by colored coating with pigments or dyes, by colored printing, or, in thermal papers, by exposure to heat.

A further embodiment of the invention relates to the use of a pressure-sensitive adhesive of the invention for producing substantially plasticizer-free, self-adhesive, redetachable paper labels.

The invention also relates to a process for producing substantially plasticizer-free, self-adhesive, redetachable paper labels, which involves providing a substantially plasticizer-free pressure-sensitive adhesive of the invention and coating a paper label at least partly with the pressure-sensitive adhesive.

### EXAMPLES

The following substances are used:

Disponil® LDBS 20 sodium dodecylbenzylsulfonate, 20% in water
Disponil® FES 27 sodium lauryl ether sulfate, 27% in water
Disponil® FES 77 sodium lauryl ether sulfate, 33% in water
DOWFAX® 2A1 disodium dodecyldiphenyl ether disulfonate

### Preparation of the Polymer Dispersions

An aqueous polymer dispersion is prepared by free-radical polymerization of the following constituents in water:

| | | | |
|---|---|---|---|
| Initial charge: | 97.19 | g | fully demineralized water |
| | 1.45 | g | polystyrene seed |
| | 3.6 | g | of feed 2 |
| Feed 1: | 340 | g | fully demineralized water |
| | 15 | g | Disponil ® LDBS 20 |
| | 10.7 | g | Disponil ® FES 27 |
| | 6 | g | acrylic acid |
| | 54 | g | n-butyl acrylate |
| | 540 | g | 2-ethylhexyl acrylate |

Disponil ® LDBS 20 can also be replaced in whole or in part by DOWFAX ® 2A1.
Disponil ® FES 27 can also be replaced in whole or in part by Disponil ® FES 77.

Feed 2: 18 g solution of sodium peroxodisulfate, 7% in water

Feeds 1 and 2 are added at a uniform rate over 3 hours at 75° C. This is followed by polymerization for 30 minutes more. The solids content of the polymer dispersion obtained is 56%.

The further dispersions 2 to 6 are prepared in the same way, with the parameters and compositions indicated in the table below.

| | | Polymerization | |
|---|---|---|---|
| | | temperature | |
| Example | Monomers1) | [° C.] | Tg [° C.] |
| 1 | 90 EHA; 9 BA; 1 AA | 75 | −67 |
| 2 | 85 EHA; 14 BA; 1 AA | 75 | −63 |
| 3 2), 3) | 0 EHA; 99 BA; 1 AA | 85 | −48 |
| 4 2) | 69.6 EHA; 29 BA; 1 AA | 90 | −55 |
| 5 2) | 90 EHA; 9 BA; 1 AA | 90 | −67 |
| 6 4) | 90 EHA; 9 BA; 1 AA | 75 | −67 |

1)Monomer composition in parts by weight, 2-ethylhexyl acrylate (EHA), n-butyl acrylate (BA) and acrylic acid (AA)
2) Comparative example
3) contains 20% by weight of diisononyl adipate (plasticizer) and as sole emulsifier 1 pphm of Disponil ® LDBS 20
4) contains as sole emulsifier 1 pphm of Disponil ® FES 77 (sodium C12/14 alkyl polyglycol ether sulfate)

### Performance Tests

The compositions of the examples were tested by coating a commercial label paper with a basis weight of 75 g/m² with 17 g/m² (solids content) of the example compositions by the transfer method via a silicone paper. The resulting labels were adhered to the test surfaces, and the bonds were aged at 60° C. for a week.

The removability (peel strength) is investigated as follows. The peel strength is the force with which an adhesive applied to a backing material opposes removal from the substrate at a defined removal speed. For the investigation of the peel strength, test strips were cut out in coating direction, in a width of 25 mm. The release paper is peeled from the test strip, and the test strip is placed onto the test substrate by hand, without additional pressure, without bubbles, using a rubber-coated laminating roller, and then rolled on. The test takes place under standard conditions (23° C., 50% relative humidity) on a tensile testing machine. In the test, the test strip is removed halfway, from the bottom end, and turned upward at an angle of 180°. The end of the test substrate that is now free is clamped into the tensile testing machine, and the test strip is removed at an angle of 180 degrees and at a machine speed of 300 mm/minute. After each measurement, the test substrate is replaced. At least 3 individual measurements are carried out. The test results are reported in N/mm width. Residues on the test surface were determined visually.

To assess the strikethrough behavior of the adhesive through the label paper, the label was aged at 50° C. for a week. Visual assessment was then made of whether there were changes, with the appearance of grease spots, visible on the label paper surface opposite the coated surface.

The results are summarized in the tables below.

| | | Peel strength on | Peel strength on |
|---|---|---|---|
| Example | Strikethrough | stainless steel | polycarbonate |
| 1 | none | 4.6 | 5.9 |
| 2 | none | 5.1 | 8.1 |
| 3 1) | clearly visible | 6.1 | 18 |
| 4 1) | visible | 7.9 | 5.2 |
| 5 1) | visible | 3.4 | 4.9 |
| 6 | none | 5.2 | 1.7 |

1) Comparative example

| | Residues after detachment | Residues after detachment |
|---|---|---|
| Example | on stainless steel | on polycarbonate |
| 1 | none | none |
| 2 | none | none |
| 3 1) | none | clearly visible |
| 4 1) | slight | none |
| 5 1) | none | none |
| 6 | clearly visible | none |

1) Comparative example

Compositions 1, 2, and 6 of the invention are notable in relation to the comparative compositions 3-5 for a significantly improved strikethrough behavior. Through the specific choice of the emulsifier combination of Examples 1 and 2 it is possible in addition to achieve particularly good residue behavior.

1. An adhesive composition, comprising:
at least one polymer prepared by polymerizing
(i) 80-95% by weight, based on a total amount of monomers, of 2-ethylhexyl acrylate, and
(ii) 5-20% by weight, based on the total amount of monomers, of at least one further ethylenically unsaturated, free-radically copolymerizable monomer different from (i), of which 0.2% to 2% by weight, based on the total amount of monomers, are a comonomer comprising at least one acid group,
wherein the polymer has a glass transition temperature of less than 61° C. and the polymerization is carried out at temperatures less than 80° C.

2. The adhesive composition according to claim 1, wherein the polymer is a pressure-sensitive adhesive composition in the form of an aqueous dispersion of the polymer, and the polymer is an adhesive emulsion polymer prepared by emulsion polymerization.

3. The adhesive composition according to claim 1, wherein the at least one further monomer is selected from the group consisting of
a C1 to C20 alkyl acrylate,
a C1 to C20 alkyl methacrylate,
a vinyl ester of carboxylic acid comprising up to 20 C atoms,
a vinylaromatic having up to 20 C atoms,
an ethylenically unsaturated nitrile,
a vinyl halide,
a vinyl ether of alcohol comprising 1 to 10 C atoms,
an aliphatic hydrocarbon having 2 to 8 C atoms and one or two double bonds,
an acrylic acid,
a methacrylic acid,
an itaconic acid,
a maleic acid, and
a fumaric acid.

4. The adhesive composition according to claim 2, wherein the emulsion polymer is prepared from
(i) 80-95% by weight, based on the total amount of monomers, of the 2-ethylhexy acrylate, and
(ii) 5-20% by weight, based on the total amount of monomers, of the at least one further monomer which is selected from the group consisting of
a C1 to C10 alkyl acrylate,
a C1 to C10 alkyl methacrylate,
an acrylic acid, and
a methacrylic acid, wherein the comonomer is acrylic acid or methacrylic acid.

5. The adhesive composition according to claim 2, wherein the emulsion polymer is prepared in the presence of a mixture of at least one first anionic emulsifier and at least one second anionic emulsifier, and the first emulsifier is an alkylarylsulfonate and the second emulsifier is an ethoxylated fatty alcohol sulfonate.

6. The adhesive composition according to claim 1, having a solids content from 40% to 70% by weight.

7. The adhesive composition according to claim 1, comprising substantially no plasticizer.

8. The adhesive composition according to claim 1, wherein one or more initiators are employed during the polymerization, and a total amount of initiator is less than 0.4 part by weight per hundred parts by weight of monomer.

9. A label, comprising:
a coating on at least a part of the label, comprising a pressure-sensitive adhesive comprising the adhesive composition according to claim 1,
wherein the label is self-adhesive and redetachable.

10. The label according to claim 9, further comprising a backing material,
wherein the backing material is selected from the group consisting of a paper, a polymeric film, and a metal foil.

11. The label according to claim 9, in the form of a paper label which comprises a first surface and a second surface,
wherein the first surface is self-adhesive and is coated at least a part of the label with a pressure-sensitive adhesive comprising the adhesive composition according to claim 1, and the second surface is printed, or the second surface or the label is at least partly colored.

12. A method for attaching a substantially plasticizer-free, self-adhesive, redetachable paper label to a surface, comprising:
contacting the label comprising a pressure-sensitive adhesive comprising the adhesive composition according to claim 1 to the surface.

13. A process for producing a substantially plasticizer-free, self-adhesive, redetachable paper label, comprising:
coating at least a part of the paper label with a substantially plasticizer-free, pressure-sensitive adhesive comprising the adhesive composition according to claim 1.
